(19) United States
(12) Patent Application Publication
(10) Pub. No.: US 2007/0159968 A1
(43) Pub. Date: Jul. 12, 2007

(54) Selective text telephony character discarding

(76) Inventor: Nicholas J. Cutaia, Brighton, MA (US)

Correspondence Address: MARGER JOHNSON & MCCOLLOM, P.C., 210 SW MORRISON STREET, SUITE 400, PORTLAND, OR, 97204, US

(21) Appl. No.: 11/331,655

(22) Filed: Jan. 12, 2006

(51) Int. Cl. H04L 12/26

(52) U.S. Cl. 370/229

(57) ABSTRACT

A network device has a port to allow the device to transmit text telephony packets over a packet network. The device includes at least one processor to detect impending buffer overflow, determine a number of text telephony characters to be dropped, and select a compression to be applied to the text telephony characters to manage buffer overflow.

### BACKGROUND

In a typical text telephony (TTY) connection over a network, such as ToIP (Text over Internet Protocol), the transmitting gateway receives text character tones from a caller through a public switched telephone network (PSTN) network. The transmitting gateway then demodulates the PSTN tones to text data, packetizes the data and transmits it to a receiving gateway. The receiving gateway receives the text data from the transmitting gateway, remodulates it and sends it to the called party on the PSTN. Both the transmitting and receiving devices are packet network-to-PSTN gateways that bridge the packet network to the PSTN.

Each of the devices are bound by the modulation protocol used to convert to and from PSTN tones, so the sustained character rate or the average characters received and transmitted is generally small enough to allow remodulation. The gateways contain buffers to store packets received from the packet network to compensate for potential jitter in the reception of packets.

If the transmitting device is not a packet network-PSTN gateway but a network-only telephony device, such as an Internet Protocol (IP) phone, the possibility exists that the character rate transmitted from the network-only telephony device will exceed the maximum character rate of the packet network-PSTN gateway The network device may have the capability to transmit text much faster than the text can be remodulated at the receiving end. The buffer that stores the text data as it waits for remodulation may overflow.

In most network devices, when buffer overflow occurs or is impending, the device generally discards packets indiscriminately. When the two parties to the call rely upon the text for communication, the results can be disastrous. The text will be nonsensical and unintelligible. Without some sort of intelligent process for determining which characters, and therefore which packets, can be discarded, text over packet networks using network only devices will not function properly.

### BRIEF DESCRIPTION OF THE DRAWINGS

Embodiments of the invention may be best understood by reading the disclosure with reference to the drawings, wherein:

FIG. 1 shows an embodiment of a text over packet network architecture.

FIG. 2 shows an embodiment of a method of selectively discarding text telephony over network packets for text telephony.

FIG. 3 shows an embodiment of a gateway to employ selective discard of text telephony over network packets.

### DETAILED DESCRIPTION OF THE EMBODIMENTS

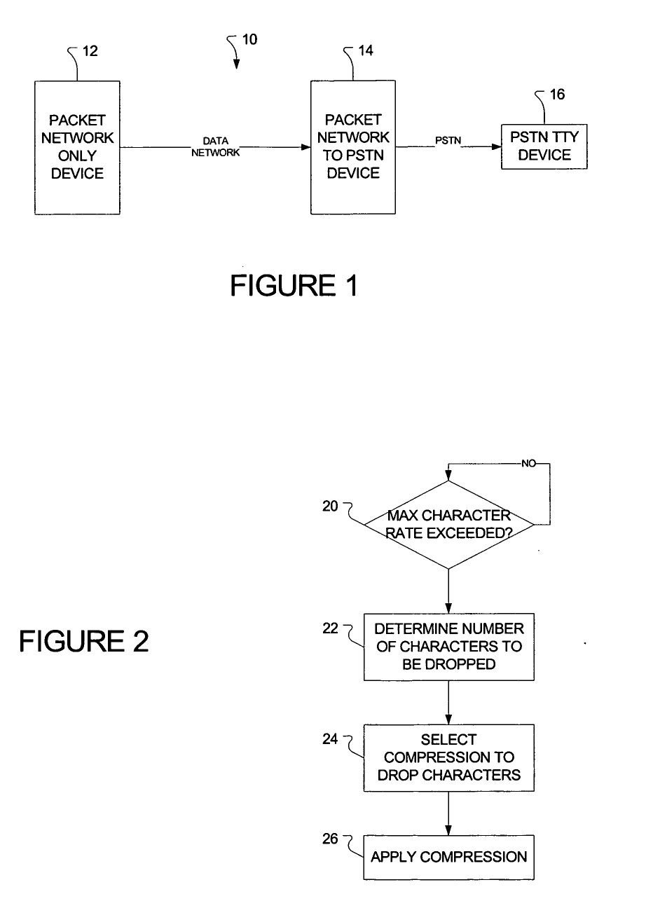

FIG. 1 shows an embodiment of a text telephony (TTY) session involving a packet network TTY transmitter and a public switched telephone network receiver. The network device 12 is a packet network only telephony device, such as an IP phone, or a computer with the necessary accessories to allow telephone calls to be placed over the packet network. The TTY data is intended for the PSTN TTY device 16, but first must undergo depacketization and remodulation into TTY tones for transmission over the PSTN connection between the packet network to PSTN gateway 14 and the device 16. Both devices do have transmit and receive capabilities, but the interaction of most interest here is from the packet network device to the PSTN device.

Prior to depacketization, the packets contain text characters whose session contents are specified in ITU-T Recommendation T.140 (International Telecommunications Union Recommendation “Protocol for Multimedia Application Text Conversation). RTP (Real-time Transfer Protocol) packets are constructed in accordance with an established standard such as RFC4103 “RTP Payload for Text Conversation” of the Internet Engineering Task Force.

Note that the term ‘remodulation’ here is somewhat of a misnomer as it implies that the data was modulated, demodulated and now requires remodulation prior to being transmitted to a PSTN TTY device. However, as that is the process that occurs between two PSTN devices communicating across a packet network, remodulation will be used to describe the conversion of the data at the receiving network.

In a connection between two PSTN TTY devices using a packet network between them, the possibility of overflowing the buffers of the receiving device is limited. Because the transmitting device has to demodulate the data from PSTN TTY to packet network packets, the process acts as a throttle on the character rate. Buffer overflow may still occur, if the two devices are using different TTY modulation protocols where the transmitting device is transmitting at a higher rate than the receiving device is remodulating.

In the situation where the transmitting device is a packet network device, the possibility exists that the buffer at the receiving device may overflow. For example, one standard can only sustain a 5.7 character/second rate without character loss at some point in the transmissions. Other modulation protocols allow higher character transmission rates, but all are limited by the TTY protocol on the PSTN circuit.

When using a packet network device, it is possible to transmit at a much higher rate. Some users may even cut and paste their TTY text into a text window and sends the buffer all at once, resulting in a much higher character rate. One proposed solution introduces a cps (character per second) parameter to limit the rate at which characters are transmitted by devices, proposed in RFC4103. While this is useful at the transmitting device to limit character rates, it is still possible that a nonconforming device may transmit data faster than the character rate. Application of the embodiments of this invention may be used to assist in limiting character rates at the transmitting device to comply with the cps parameter. In either respect, the embodiments will allow either the transmitting or receiving device to avoid or at least mitigate the effects of buffer overflow on a TTY session.

FIG. 2 shows an embodiment of a method of handling or avoiding buffer overflow in the receiving device. While the buffer overflow occurs at the receiving end of the session, that end that is connected to the PSTN TTY device, the method may be implemented at either end of the session, local to the buffer at the receiving end, or remote from the buffer at the transmitting end. At 20, the event of maximum character rate being exceeded is detected. This will be addressed both on the receiving side and the transmitting side.

On the receiving side, the maximum character rate being exceeded is detected as imminent buffer overflow in the packet network to PSTN device. How close to overflow the buffer is allowed to get before the methods described here operate is left up to the system designer.

Detection of buffer overflow may be accomplished in many ways. For example, the status of the buffer could be monitored as to how full it has become. When the buffer reaches a particular threshold, the process may begin to manage the impending buffer overflow.

On the transmitting side, where a packet network only device is transmitting to a packet network to PSTN device, the average character per second transmission rate can be estimated and compared against the receiving device's sustainable character rate per second. If the sustainable rate is higher than the estimate of the actual rate, buffer overflow at the receiving device will not occur and the process will cycle along the ‘NO’ branch of the diagram. If the sustainable rate is lower than the estimate of the actual rate, buffer overflow will occur. It is possible to determine the length of time at which the buffer can operate at the higher rate before overflow occurs, if desiring to limit the amount of time during which the rate reduction techniques are used.

Once the maximum character rate being exceeded is detected, a number of characters to be dropped is determined at 22. The number of characters to be dropped depends upon by how many characters per second the rate needs to be reduced. It is possible to define a character rate offset that is the difference between the estimated received character rate and the sustainable character rate. The number of characters to be dropped may generally be proportional to the character rate offset.

After determining a number of characters to be dropped, a compression is applied to the text telephony stream to reduce the number of characters at 24. Different compression techniques may be employed. For example, word compression may be employed. Word compression includes use of standard TTY abbreviation dictionaries in which common TTY abbreviations are used. Word compression may also include whole word replacement, where such words such as ‘avenue,’ and ‘message’ are replaced with ‘ave’ and ‘msg,’ as examples.

Phrase compression is another technique that can be used to reduce character rate. Some of these may be familiar from what is sometimes referred to as ‘net speak’ such as ‘lol’ meaning ‘laughing out loud;’ ‘ttyl’ replacing ‘talk to you later;’ or ‘r u’ replacing ‘are you.’

Vowel removal may also work, where vowels are removed from words of a certain length. The length of the words may be selectable by the user(s) or the system designer. Examples include ‘rsplndnt’ instead of ‘resplendent;’ ‘smthng’ instead of ‘something;’ ‘Csco’ instead of ‘Cisco.’ Yet another technique is to remove punctuation.

The user(s) could also select the compression technique used, either by agreement between them during the beginning of the call, or by one or the other users disabling a particular type of compression. For example, if one user does not feel comfortable with phrase compression, that user may disable the capability and the other user's device may detect the disabling of that capability. Additionally, the users may exchange their own dictionaries of compressions prior to the TTY session. Indeed, the preferences for one user may be stored by the other user, if the two users communicate across TTY frequently.

Another issue may arise with the use of abbreviation dictionaries. There may be a training period needed for some language dependencies. During the training period, common keyword spotting may be employed to determine the language and the abbreviation language suitable for that language.

Returning to FIG. 2, once the compression technique has been selected at 24, the application of that technique is performed at 26. As was mentioned with regard to the detection of impending buffer overflow on the receiving side, the start of compression may result from the buffer reaching a particular ‘full’ threshold. The compression may continue until the buffer reaches a particular ‘not full’ threshold, where the second threshold is lower than the first threshold. Alternatively, on the transmitting side the estimated actual character rate may drop below the sustainable character rate, and compression may discontinue at that point.

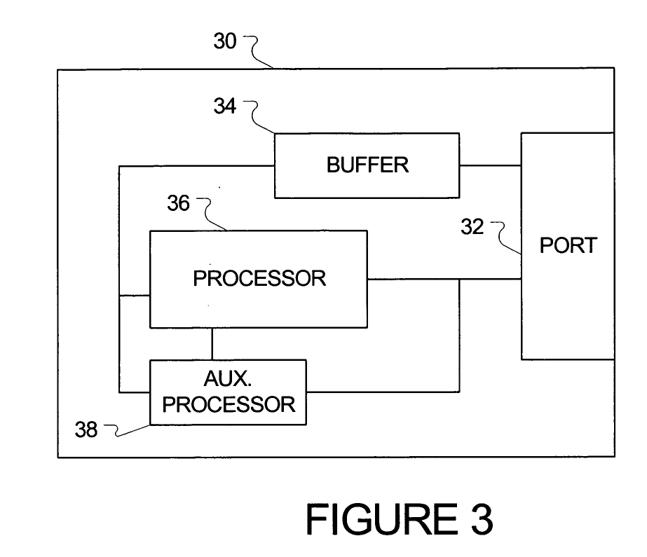

As was mentioned above, the detection and management of buffer overflow may occur at either end of the session. The devices 12 or 14 from FIG. 1 will more than likely perform the detection of overflow and the resulting compression. FIG. 3 shows an embodiment of such a network device.

The device 30 has a port 32 which may connect the device to the packet network and the PSTN, one or the other. In some instances, the device will have two ports, one for the packet network and one for the PSTN.

The buffer 34 has different effects depending upon whether the device is a packet only network device or a packet network to PSTN device. For the packet network to PSTN device that is implementing the methods of the invention, the buffer 34 is the buffer being monitored for overflow that would trigger the beginning of compression.

For the packet network only device that may perform the character compression in the transmit direction, the buffer 34 may be a transmit buffer where text data would be ‘quarantined’ before transmission to make sure the character rate isn't exceeded.

The processor 36 operates the network device 30 as its central processing unit. This may comprise more than one processor. Further, the detection of buffer overflow conditions and the compression may be performed by the central processing unit itself, or in conjunction with an auxiliary processor 38. The functions may be passed from the central processor to the auxiliary processor and back, be processed to completion at the auxiliary processor, or any combination thereof. Further, the central processing unit may divide the functions between the processors, having one perform the detection and the other manage and apply the compression.

It must be noted that the auxiliary processor may be the same type of processor with the same capabilities and capacity as the central processing unit. The processors may be configured to be a multiple processor architecture with the functions divided between them. In other embodiments, one processor may be a general purpose processor and the other a digital signal processor, as an example.

Indeed, the implementation of the embodiments may be accomplished by loading new software code into the processor or processors of an existing gateway. In this case, the methods of the embodiments would be implemented as an article of computer-readable media containing instructions that, when executed, cause the computer to implement the methods described above. The computer in this instance would be either the packet network only device or the packet network to PSTN device.

Thus, although there has been described to this point a particular embodiment for a method and apparatus for avoiding buffer overflow in TTY over packet networks devices, it is not intended that such specific references be considered as limitations upon the scope of this invention except in-so-far as set forth in the following claims.

What is claimed is:

1. A network device, comprising:
a port to allow the device to communicate text telephony packets over a packet network; and
at least one processor to:
detect a maximum character rate being exceeded;
determine a number of text telephony characters to be dropped; and
select a compression to be applied to the text telephony characters to manage buffer overflow.

2. The network device of claim 1, the network device further comprising a port to allow the device to communicate using text telephony over a circuit switched network.

3. The network device of claim 1, the port further to allow the device to communicate using text telephony over a circuit switched network.

4. The network device of claim 1, the network device further comprising a transmitting gateway receiving text telephony over a circuit network and transmitting text telephony packets over a packet network.

5. The network device of claim 4, the processor to detect a maximum character rate being exceeded further comprising the processor to detect impending buffer overflow on a receiving gateway.

6. The network device of claim 1, the network device further comprising a receiving gateway receiving text telephony packets over a packet network and transmitting text telephony over a circuit network.

7. The network device of claim 1, at least one processor to detect a maximum character rate being exceeded further comprising the processor to detect impending buffer overflow on the receiving gateway.

8. The network device of claim 1, at least one processor further comprising a combination of a central processing unit and at least one digital signal processor.

9. The network device of claim 8, the digital signal processor further comprising a digital signal processor to apply the compression to the text telephony characters.

10. A method of compression text telephony data, comprising:
detecting a maximum character rate being exceeded;
determining a number of text telephony characters to be dropped; and
applying a compression to the text telephony data based upon the number of text telephony characters to be dropped.

11. The method of claim 10, further comprising determining a language of the text telephony data.

12. The method of claim 11, further comprising using common keyword spotting to determine the language.

13. The method of claim 10, detecting a maximum character rate being exceeded further comprising detecting an impending buffer overflow in a local buffer.

14. The method of claim 10, detecting a maximum character rate being exceeded further comprising detecting a maximum character rate being exceeded for characters being transmitted to a packet network to PSTN device.

15. The method of claim 10, detecting a maximum character rate being exceeded further comprising determining that a buffer has reached a predetermined threshold.

16. The method of claim 10, detecting a maximum character rate being exceeded further comprising determining that an average character rate is above an allowable sustained character rate.

17. The method of claim 10, determining a number of characters to be dropped further comprising determining a character rate offset and setting the number of characters to be dropped to be proportional to the character rate offset.

18. The method of claim 10, applying a compression further comprising applying one of the group consisting of: phrase compression, vowel removal, word compression, and punctuation removal.

19. The method of claim 10, applying a compression further comprising allowing a user to select a compression.

20. The method of claim 10, applying a compression further comprising applying a mutually-agreed upon compression dictionary.

21. A network device, comprising:
a means for allowing the device to communicate over a circuit network using text telephony;
a means for allowing the device to transmit text telephony packets over a packet network; and
at least one processing means for:
detecting a maximum character rate being exceeded;
determining a number of text telephony characters to be dropped; and
selecting a compression to be applied to the text telephony characters to manage buffer overflow.

22. The network device of claim 21, at least one processing means further comprising a combination of a central processing unit and at least one digital signal processor.

23. The network device of claim 22, the digital signal processor further comprising a digital signal processor to apply the compression to the text telephony characters.

24. An article of computer-readable media containing instructions that, when executed, cause the computer to:
detect a maximum character rate being exceeded;
determine a number of text telephony characters to be dropped; and
apply a compression to the text telephony data based upon the number of text telephony characters to be dropped.

25. The article of claim 24, the instructions further causing the computer to determine a language of the text telephony data.

26. The article of claim 24, the instructions further causing the computer to use common keyword spotting to determine the language.
